(19) United States
(12) Patent Application Publication
(10) Pub. No.: US 2012/0250153 A1
(43) Pub. Date: Oct. 4, 2012

(54) TWO-LENS DEVICE AND STEREOSCOPIC IMAGING APPARATUS WITH TWO-LENS DEVICE

(76) Inventors: Aiichiro KAWASAKI, Kanagawa (JP); Nahoko Uno, Tokyo (JP); Masahito Kikuchi, Tokyo (JP)

(21) Appl. No.: 13/426,968

(22) Filed: Mar. 22, 2012

(30) Foreign Application Priority Data
Mar. 29, 2011 (JP) 2011-073321
Sep. 7, 2011 (JP) 2011-194623

(51) Int. Cl. G02B 27/22

(52) U.S. Cl. 359/477

(57) ABSTRACT

A two-lens device includes two lens portions that are disposed so as to be laterally aligned, a lens case that supports the two lens portions in a state where a convergence point can be adjusted in order to image a subject as stereoscopic images by the two lens portions, and a filter installation portion at which a single circular optical filter covering the entire surface of the subject side of the two lens portions is installed so as to be attachable and detachable through thread connection on the subject side of the two lens portions of the lens case.

### BACKGROUND

The present disclosure relates to a two-lens device which can image a subject as stereoscopic images and a stereoscopic imaging apparatus with two-lens device including the two-lens device. Particularly, the present disclosure relates to a fitting structure of an external optical filter used as an attachment of the two-lens device.

Generally, in a lens device of the imaging apparatus such as a digital camera or a video camera, various kinds of optical filters are used in order to protect lenses or restrict passing light.

In the related art, as a fitting structure of the optical filter for the imaging apparatus with a single lens device, there is a structure disclosed in Japanese Unexamined Patent Application Publication No. 2007-272163. Japanese Unexamined Patent Application Publication No. 2007-272163 discloses a technique relating to an optical filter and a lens hood installed at the front end of the lens barrel of the camera so as to be used. The camera disclosed in Japanese Unexamined Patent Application Publication No. 2007-272163 is provided with a single lens device having a cylindrical lens barrel, and lens barrel frame threads are provided on the inner circumferential surface of the front end of the lens barrel such that the optical filter is attachable and detachable. A female screw groove is provided on the inner circumferential surface of the front end of the optical filter, and the lens hood having a male screw groove which can be screwed into the female screw groove is configured so as to be attachable to and detachable from the filter.

In the single lens device of the camera, an external optical filter is installed at the front end of the lens barrel so as to be attachable and detachable, or other optical filters are connected thereto in the optical axis direction in an overlapping manner so as to be attachable and detachable.

Such a use form of the optical filters is also the same for the two-lens device and the stereoscopic imaging apparatus with the two-lens device.

In recent years, a two-lens type stereoscopic imaging apparatus capable of performing stereoscopic photographing (3D photographing) has been proposed. The two-lens type stereoscopic imaging apparatus has a configuration where two single-lens devices are laterally aligned, and the two single-lens devices are disposed substantially in parallel to each other with a predetermined gap (IAD: Inter-Axial Distance).

In the two-lens type stereoscopic imaging apparatus, there are six issues to be considered in order to obtain comfortable 3D stereoscopy. First, “deviation in the vertical direction”, second, “deviation of an angle of view”, third, “difference in brightness or color”, fourth, “deviation of rotation”, fifth, “correct parallax adjustment”, and, sixth, “appropriate composition”, are to be considered. Of them, in a two-lens type stereoscopic imaging apparatus where two lens devices are integrally combined with each other, the first to fourth issues can be solved by internal mechanisms, but it is necessary for the fifth and sixth issues to be finely adjusted every time according to a composition of the subject.

In addition, with regard to the fifth issue “correct parallax adjustment”, a “distance between lens devices” and a “distance of the cross-point (convergence)” are problematic. First, in relation to the “distance between lens devices”, about 65 mm which is substantially the same as the gap between a pair of human eyes is set as an inter-axial distance. A convergence point (a reference surface of the 3D images) is adjusted forward and backward by changing convergence angles of the two-lens devices in the optical unit, and thereby “protrusion” out of and “depth” into the screen are controlled.

The stereoscopic imaging apparatus with the two-lens device has also necessity of the optical filter in the same manner as a typical camera (an imaging apparatus with a single lens device). In this case, if the same use method as in the above-described imaging apparatus with the single lens device is applied to the stereoscopic imaging apparatus with the two-lens device, there is concern that the following problems may occur.

FIG. 10 is a diagram illustrating by a cross-section a front end portion on the subject side in two-lens portions 101 and 102 of the stereoscopic imaging apparatus with two-lens device. The two-lens portions 101 and 102 are disposed to be laterally aligned such that the optical axes C1 and C2 are substantially parallel to each other, and object side lenses 104R and 104L are respectively fixed around the front end of the lens barrel 103. A female thread is provided on the inner circumferential surface of the front end of each lens barrel 103, and each of the optical filters 105R and 105L having a male thread screwed into the female thread is connected thereto by the threads.

Now, if, in FIG. 10, an incidence angle of light incident to each of the object side lenses 104R and 104L is φ°, an imaging surface of the left lens portion 102 with respect to the imaging surface F is FL, and an imaging surface of the right lens portion 101 is FR, an overlapping surface FC is generated between the left and right imaging surfaces FL and FR. Since stereoscopic images are obtained by overlapping the left and right imaging surfaces FL and FR, the overlapping surface FC obtained by the left imaging surface FL and the overlapping surface FC obtained by the right imaging surface FR are preferably the same imaging surface. In addition, the reference numeral C1 denotes an optical axis of the right lens portion 101, and the reference numeral C2 denotes an optical axis of the left lens portion 102.

However, depending on the kind of optical filters, there are cases where a purpose of using the filter may not be achieved. For example, one of the cases is a case where, if a polarization filter is used as an optical filter, a starting end of the thread provided on the filter frame is different from a polarization angle of the filter fixed to the frame between two polarization filters. In this case, polarization angles of the optical filters 105R and 105L installed at the right and left lens portions 101 and 102 become different from each other, and thereby there are cases where an exposure amount may be different in the left and right, or a rate of removing reflection light may be different.

### SUMMARY

It is desirable to solve the problem that, if optical filters are separately installed and used in two-lens portions of a stereoscopic imaging apparatus with two-lens device, a purpose thereof may not be achieved depending on the kind of optical filters, and rather the imaging surface is deteriorated.

According to an embodiment of the present disclosure, there is provided a two-lens device including two lens portions that are disposed so as to be laterally aligned; a lens case that supports the two lens portions in a state where a convergence point can be adjusted in order to image a subject as stereoscopic images by the two lens portions; and a filter installation portion at which a single circular optical filter covering the entire surface of the subject side of the two lens portions is installed so as to be attachable and detachable through thread connection on the subject side of the two lens portions of the lens case.

According to another embodiment of the present disclosure, there is provided a stereoscopic imaging apparatus with two-lens device including a two-lens device that can image a subject as stereoscopic images; an imaging apparatus body at which the two-lens device is installed so as to be attachable and detachable; and two imaging device units that are fitted to the two-lens device or the imaging apparatus body and have imaging devices.

The two-lens device includes two lens portions that are disposed so as to be laterally aligned; a lens case that supports the two lens portions in a state where a convergence point can be adjusted in order to image a subject as stereoscopic images by the two lens portions; and a filter installation portion at which a single circular optical filter covering the entire surface of the subject side of the two lens portions is installed so as to be attachable and detachable through thread connection on the subject side of the two lens portions of the lens case.

In the two-lens device and the stereoscopic image apparatus with two-lens device according to the embodiments of the present disclosure, if the optical filter is installed in the lens case through thread connection, the entire surface of the subject side of the two lens portions is covered by the circular single optical filter. For this reason, since the two lens portions are covered by the single optical filter at all times, it is possible to achieve the same optical filter effect at all times between the two lens portions.

### BRIEF DESCRIPTION OF THE DRAWINGS

FIG. 1 is an exterior perspective view illustrating an example of the two-lens device according to an embodiment of the present disclosure.

FIG. 2 is a diagram illustrating characteristics of the two-lens device shown in FIG. 1.

FIG. 3 is a side view when the two-lens device shown in FIG. 1 is viewed from an adjustment ring side.

FIG. 4 is an exterior perspective view of a lens unit related to the two-lens device shown in FIG. 1.

FIG. 5 is a side view of the lens barrel and the imaging device unit of the lens unit shown in FIG. 4.

FIG. 6 is a graph illustrating the diameter of the object side lens when the object side lens is designed for use in various imaging device sizes.

FIG. 7 is a graph illustrating the dimension of the imaging device IC mount substrate when the imaging device IC mount substrate is designed for use in various imaging device sizes.

FIG. 8 is a side view illustrating an example of the stereoscopic imaging apparatus with two-lens device, which uses the two-lens device shown in FIG. 1.

FIG. 9 is a diagram illustrating by a cross-section main parts in a state where a single optical filter is installed at the two-lens device shown in FIG. 1.

FIG. 10 is a diagram illustrating by a cross-section main parts in a state where two optical filters are separately installed at two lens portions of the two-lens device according to the related art.

### DETAILED DESCRIPTION OF EMBODIMENTS

A filter installation portion which is constituted by a cylindrical shaft portion capable of covering outsides of two lens portions on the subject side is provided in a lens case such that a single optical filter installed at the filter installation portion covers the entire surface of the two lens portions on the subject side. Thereby, it is possible to implement a two-lens device and a stereoscopic imaging apparatus with the two-lens device, capable of achieving the same filter effect by the single optical filter at all times between the two lens portions, with a simple configuration.

### EXAMPLES

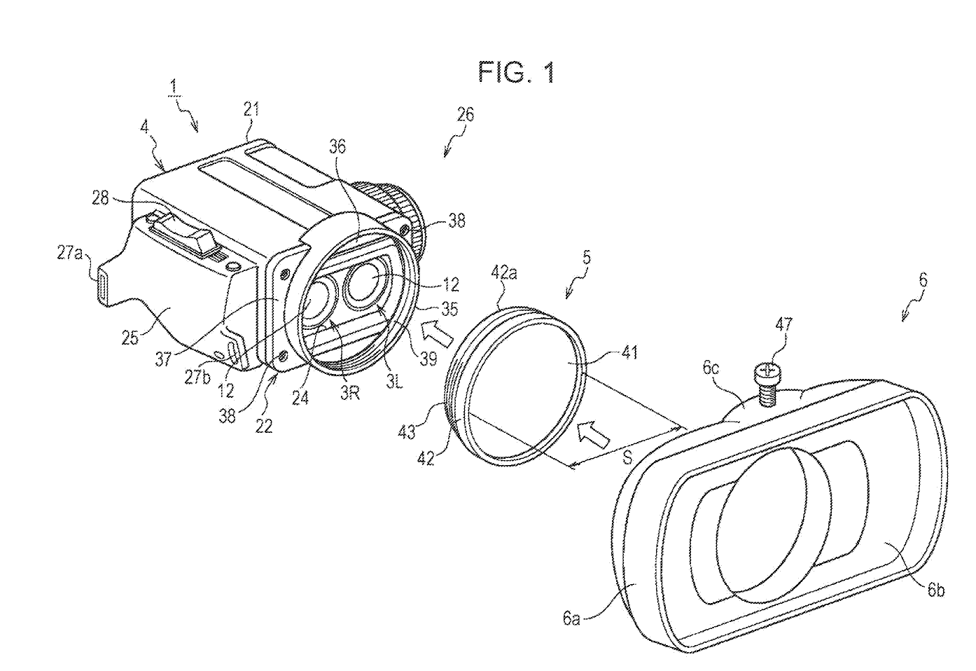

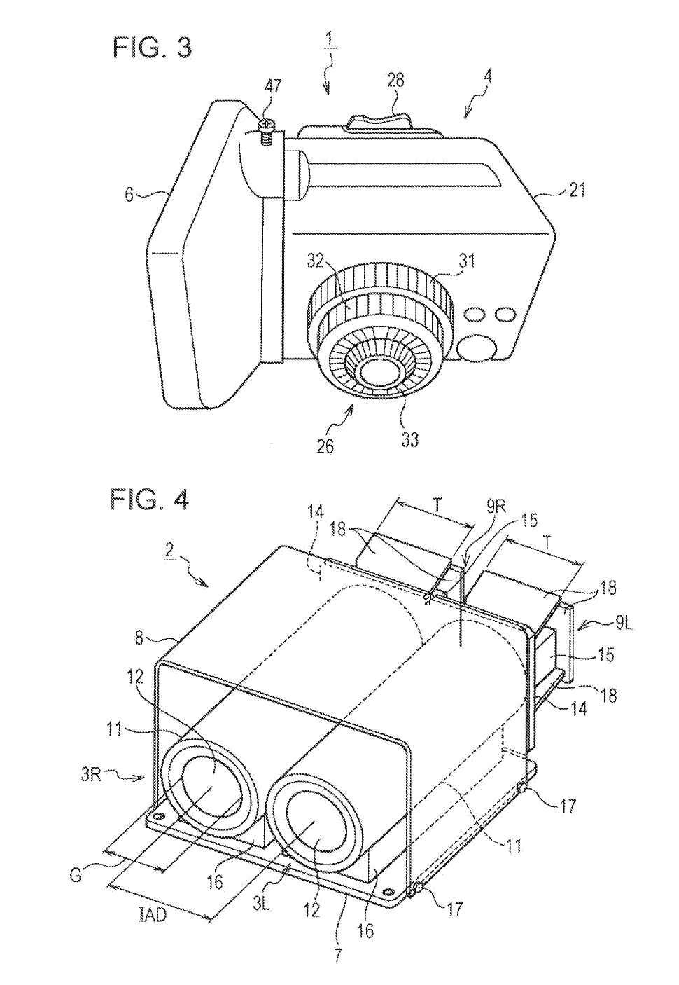

FIGS. 1 to 3 are diagrams illustrating an example of the two-lens device which can image a subject as stereoscopic images according to an embodiment of the present disclosure. The two-lens device 1 includes a lens unit 2 having two lens portions 3L and 3R, and a lens case 4 in which the lens unit 2 is accommodated. Further, the two-lens device 1 is provided with an optical filter 5 and a lens hood 6 as constituent components or attachments.

The lens unit 2 has a configuration as shown in FIG. 4. FIG. 4 is a diagram illustrating an example of the lens unit related to the two-lens device 1 according to the embodiment. The lens unit 2 includes the two lens portions 3L and 3R constituted by the left lens portion 3L and the right lens portion 3R, a base plate 7, a cover plate 8, and the like. Each of the two lens portions 3L and 3R includes a lens barrel 11 formed by a cylindrical body and a plurality of lenses and prisms which are fixed or are supported so as to be moved inside the lens barrel 11, and has the same structure using the same constituent components. A lens which is disposed at a position closest to a subject is an object side lens 12 for each of the lens portions 3L and 3R.

The left and right lens systems supported by the two lens barrels 11 and 11 are laterally aligned such that the respective optical axes are substantially parallel to each other, and are configured such that a cross-point of the left and right lens portions 3L and 3R can be adjusted through a rotation operation of a convergence ring described later. A coupling member 14 having a wire pattern of a predetermined shape is fitted to each of the two lens barrels 11 and 11. A through-hole matching with the optical axis of each lens system is provided at each of the coupling members 14. Two imaging device units 9L and 9R are fitted to the coupling members 14.

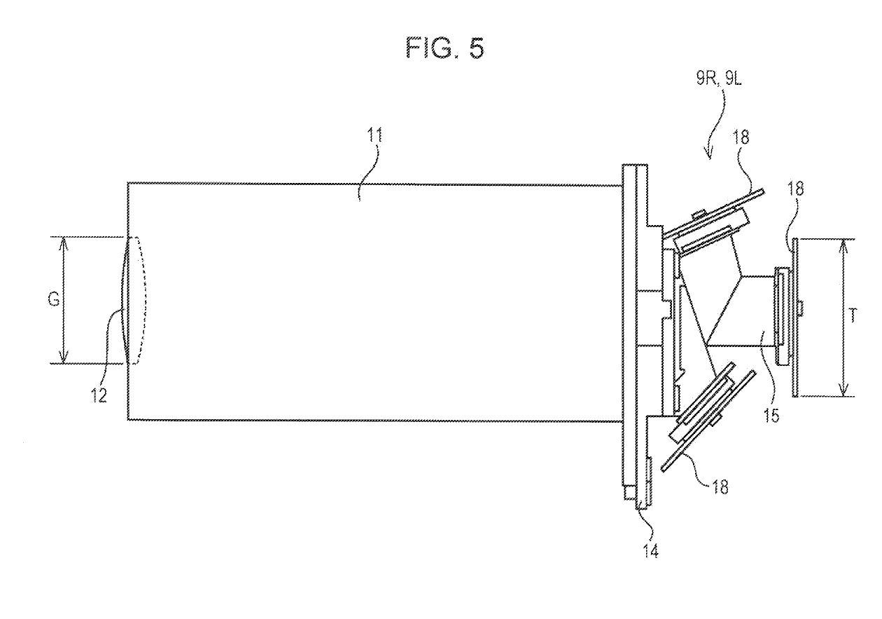

As shown in FIG. 5, each of the two imaging device units 9L and 9R has three imaging device IC mount substrates 18 on which imaging devices are mounted, and a color separation and synthesis prism 15. The color separation and synthesis prism 15 is disposed outside of the through-hole of the coupling member 14 and on the optical axis thereof. The color separation and synthesis prism 15 separates light incident from the lens barrel 11 into R (red), G (green), and B (blue). In addition, the three imaging device IC mount substrates 18 are disposed at the color separation and synthesis prism 15.

Each of the three imaging device IC mount substrates 18 is formed in a nearly square plate shape. The three imaging device IC mount substrates 18 respectively have imaging devices corresponding to R light, G light, and B light, mounted thereon. As the imaging devices, for example, a CMOS (Complementary Metal Oxide Semiconductor) image sensor, or a CCD (Charge Coupled Device), or the like may be used.

In addition, although the example where the three imaging devices are provided in each of the two imaging device units 9L and 9R here, the present disclosure is not limited thereto. For example, a single imaging device may be provided such that light incident from the lens barrel 11 is not separated, and thus light is sensed by the single imaging device.

Supporting blocks 16 and 16 which have a V block shape and protrude outwardly in the radius direction are provided on the outer circumferences of the two lens barrels 11 and 11. The two lens portions 3L and 3R are installed on the base plate 7 such that positions thereof can be adjusted via the supporting blocks 16 and 16. The base plate 7 is formed by a rectangular plate-shaped member, and the cover plate 8 is fastened to the base plate 7 with a plurality of fixing screws 17 so as to be attachable and detachable. The cover plate 8 includes an upper portion 8a covering the upper sides of the two lens barrels 11 and 11, and left and right lateral surface portions 8b and 8b which continuously extend downwardly from the left and right sides of the upper portion 8a, and the lower end of each lateral surface portion 8b is fixed to the lateral end surface of the base plate 7 with the fixing screws 17.

The lens case 4 has a configuration as shown in FIGS. 1 to 3. In other words, the lens case 4 includes a case body 21 having a square shape, and a front member 22 which is fitted so as to close an opening of the front surface of the case body 21 and is fastened thereto with fixing screws 38 so as to be attachable and detachable. A unit accommodating portion, which is formed by a space for accommodating the lens unit 2, is provided inside the case body 21. When the lens unit 2 is accommodated at a predetermined position of the unit accommodating portion, the two object side lenses 12 and 12 of the left and right lens portions 3L and 3R are exposed from the transversely long opening 24 which is provided nearly at the center of the front member 22.

A grip portion 25 is provided on the right lateral surface of the lens case 4, and an adjustment ring 26 is provided on the left lateral surface thereof. The grip portion 25 is formed by a protrusion which has a shape and a size suitable to be grasped with one hand of a user, and is provided with band fitting portions 27a and 27b to which bands (not shown) are fitted. Further, the grip portion 25 is provided with an oscillation type wide angle/telescopic switch 28 which allows a wide angle and stereoscopic view to be adjusted. If one end of the angle/telescopic switch 28 is continuously pressed, wide angle adjustment progresses according to a pressing amount thereof, and if the other end is continuously pressed, stereoscopic view adjustment progresses according to a pressing amount thereof.

The adjustment ring 26 includes a zoom ring 31 for zoom adjustment, a focus ring 32 for focus adjustment, and a convergence ring 33 for convergence adjustment. The zoom ring 31, the focus ring 32, and the convergence ring 33 are combined with nested structures so as to rotate on the same axis, and can rotate in the forward and reverse directions independently from each other. More specifically, the zoom ring 31 is a rotation portion which is located at the outermost side in the adjustment ring 26, and the focus ring 32 is a rotation portion which is located at the inside of the zoom ring 31. In addition, the convergence ring 33 is a rotation portion which is located at the inside of the focus ring 32.

By locating the three rings in this way, a user can intuitively know an adjustment target from the outer diameters of the rings along with a positional relationship between the rings which are adjusted, and thereby it is possible to improve operability. In addition, the outer circumferential surfaces of the zoom ring 31 and the focus ring 32 have knurling for non-slipping, and the end surface of the convergence ring 33 has knurling for non-slipping.

The front member 22 fitted to the front surface of the case body 21 has a cylindrical ring portion 35, an end surface portion 36 which is developed inside the ring portion 35, and a base portion 37 for fixing the ring portion 35 to the case body 21. The opening 24, which is formed in a transversely long shape, is provided nearly at the center of the end surface portion 36 so as to expose the left and right object side lenses 12 and 12 of the lens unit 2. The base portion 37 is formed by a protrusion which protrudes toward both sides in the diameter direction of the ring portion 35, and the front member 22 is integrally fixed to the case body 21 with a plurality of screws 38 which are inserted into insertion holes provided in the base portion 37.

A female thread 39 for connection to the optical filter 5 through thread connection so as to be attachable and detachable is provided on the inner circumferential surface of the ring portion 35 of the front member 22. Although the shape, size, pitch and the like of the female thread 39 of the optical filter 5 may be appropriately set, it is preferable to use a unified size female thread corresponding to a unified size male thread which is applied to the optical filter which is commercially available. The ring portion 35 forms a detailed example of the filter installation partition. The optical filter 5 includes a circular filter portion 41 which is formed to have an appropriate diameter, and a ring-shaped frame portion 42 which is fitted to the filter portion 41. The frame portion 42 has a ring-shaped cylindrical shaft portion 42a which protrudes to one surface side of the filter portion 41, and a male thread 43 which can be screwed into the female thread 39 provided in the ring portion 35 is provided on the outer circumferential surface of the cylindrical shaft portion 42a.

The optical filter 5 may employ a variety of filters but, in the present disclosure, is limited to a circular filter in the classification depending on shapes and is limited to a thread type in the classification depending on installation specification. In addition, a glass filter and a plastic filter may be employed in the classification depending on materials. Further, in the classification depending on filter effects, a polarization (PL) filter, a neutral density (ND) filter, a sharp cut (SC) filter, a color filter for highlighting effect, a light balancing (LB) filter, a color correction (CC) filter, an infrared filter, a lens protection filter, or the like may be employed. Moreover, as the optical filter 5, a get white balance filter, a removing irregular reflection (DR) filter, a soft filter, a cross filter, or the like may be employed.

In addition, as the sharp cut filter, there is an ultraviolet cut (UV) filter, a black and white contrast control filter, a preparation for black and white color filter, an infrared film filter, an HF glass, or the like. In addition, as the color correction filter, there is a fluorescent lamp (FL-W) filter, a TV screen shot (TV-CC) filter, or the like. As the soft filter, there is a Duto filter, a Softon filter, a foggy filter, or the like. Further, as the cross filter, there is a snow-cross filter, a sunny-cross filter, a vari-cross filter, or the like.

In addition, the optical filter may be integrally formed with the lens unit 2 instead of being attachable and detachable. Further, the optical filter may be configured using a dedicated optical filter instead of a commercial product.

Generally, the gap between a pair of human eyes is about 65 mm for an adult, and the gap between both the eyes corresponds to an inter-axial distance (IAD, also referred to as “parallax”) of the two lens portions 3L and 3R of the lens unit 2. In addition, a subject is viewed such that the lines of sight (optical axes) of the left and right lens portions 3L and 3R slightly face inwards, thereby obtaining the stereoscopic effect, and a point at which the optical axes of the left and right lens portions 3L and 3R intersect each other is a convergence point. The convergence angle corresponds to a human eye intersection angle, and the lines of sight thereof slightly face inwards.

In this case, it is possible to widen a 3D photographing region by making the IAD (Inter-Axial Distance) so as to be narrower than the adult's parallax 65 mm. In the rig type 3D camera (HD camera), the IAD was 0 to 70 mm. In contrast, in a stereoscopic photographing camera where two lens portions are integrally formed, the IAD has a reverse relationship with “a lens (F-number) and a captured image”.

If the IAD is a small value, it is necessary for “the diameter G of the lens portion (object side lens), the prism dimension, the IC package dimension of imaging device, and imaging device IC mount substrate T” to be decreased, and thereby the lens (F-number) is darkened and S/N image quality is deteriorated. In contrast, a stereoscopic imaging region in this case is widened.

On the contrary thereto, if the TAD is a large value, it is necessary for “the diameter G of the lens portion (object side lens 12), the prism dimension, the IC package dimension of imaging device, and the dimension T of the imaging device IC mount substrate 18” to be increased, and thereby the lens (F-number) is brightened and S/N image quality is improved. In contrast, a stereoscopic imaging region in this case narrows.

Therefore, a value of the IAD (:Y) is preferably set in a range of 30<Y<60 (unit: mm), and the IAD is preferably suppressed to about 45 mm in order to obtain a very suitable stereoscopic image from a relatively short distance of about 1 m.

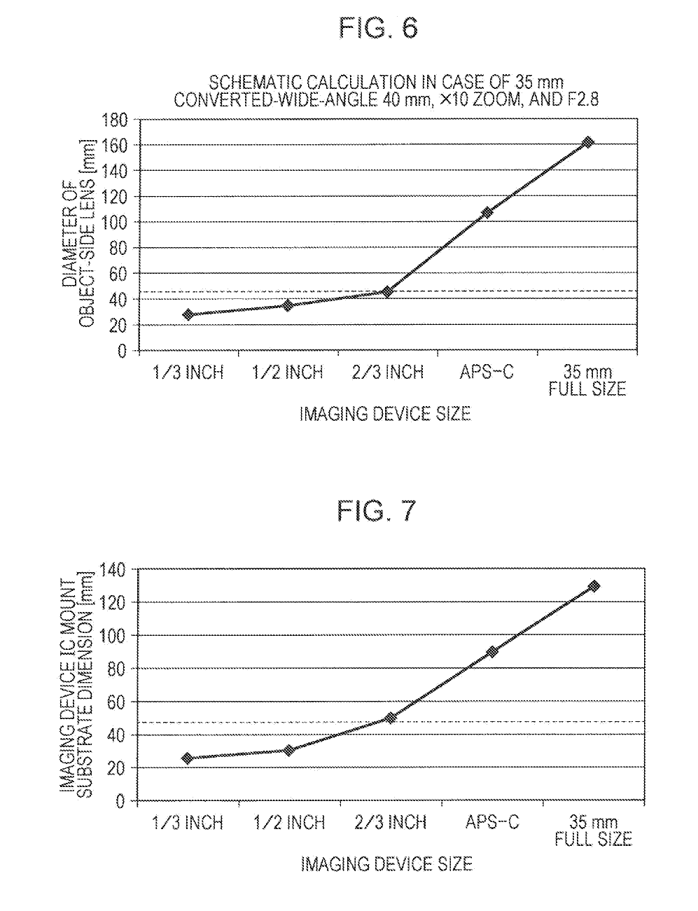

Next, with reference to FIG. 6, there will be made a description of the diameter G of the object side lens 12 and the size of the imaging device necessary to obtain very suitable stereoscopic images.

FIG. 6 is a graph illustrating the diameter of the object side lens 12 when the object side lens 12 is designed for use in various kinds of imaging device sizes. Conditions in the graph shown in FIG. 6 are magnification ten times, F2.8, and an angle of view of about 40 mm which is converted into a full size.

As described above, it is necessary to suppress the IAD to about 45 mm in order to capture favorable stereoscopic images. For this reason, the diameter G of the object side lens 12 is preferably equal to or less than 45 mm. Therefore, as shown in FIG. 6, it can be seen that if the diameter G of the object side lens 12 is equal to or less than 45 mm, it is necessary to suppress the imaging device size to ⅔ inch or less.

In addition, in a case of using an imaging device of the ASP-C size or the 35 mm full size, the diameter G of the object side lens 12 is 100 mm or more. In a case where the object side lens 12 having the diameter G of 100 mm or more is used as each of the lens portions 3L and 3R, the magnitude of the IAD exceeds 100 mm. For this reason, a stereoscopic imaging region narrows, and thus very suitable stereoscopic images may not be obtained.

Next, with reference to FIG. 7, there will be made a description of the dimension T of the imaging device IC mount substrate 18 and the imaging device size necessary to obtain very suitable stereoscopic images.

FIG. 7 is a graph illustrating the dimension T of the imaging device IC mount substrate 18 when the imaging device IC mount substrate 18 is designed for use in various kinds of imaging device sizes.

As shown in FIG. 7, if the imaging device size is 1/3 inch and ½ inch, the dimension T of the imaging device IC mount substrate 18 does not have a large difference. However, if the imaging device size is larger than ½ inch, it can be seen that the dimension T of the imaging device IC mount substrate 18 is increased.

Here, as shown in FIG. 4, the imaging device IC mount substrates 18 are disposed on the rear side of the lens portions 3L and 3R which are disposed so as to be laterally aligned in the direction perpendicular to the optical axis. For this reason, the imaging device IC mount substrates 13 are disposed so as not to interfere with the adjacent imaging device IC mount substrates 18 of the imaging device units 9L and 9R. Therefore, if the dimensions T of the imaging device IC mount substrates 18 are increased, the gap between the two lens portions 3L and 3R is also increased.

In addition, as described above, it is necessary to suppress the IAD to about 45 mm in order to capture favorable stereoscopic images. For this reason, the dimension T of the imaging device IC mount substrate 18 is preferably equal to or less than 45 mm. Therefore, as shown in FIG. 7, when the dimension T of the imaging device IC mount substrate 18 is equal to or less than 45 mm, it can be seen that the imaging device size is suppressed to ⅔ inch or less.

In addition, in order to prevent deterioration in image quality, the imaging device size is preferably equal to or more than ¼ inch. Therefore, in consideration of the diameter G of the object side lens 12, the dimension T of the imaging device IC mount substrate 18, and image quality to be obtained, the size of the imaging device (: X) is ¼<X<⅔ (unit: inch).

A preferable combination of the values is, for example, a case where the lens IAD is 45 mm, and the imaging device size is ½ inch.

As such, it is possible to widen a stereoscopic imaging region and obtain stereoscopic images of high image quality by setting the IAD to “30<Y<60” narrower than the adult's parallax 65 mm and applying “¼X<⅔” to the stereoscopic imaging region. The stereoscopic imaging apparatus may be applied to consumer use imaging apparatuses, but most effectively achieves its purpose through application to business use imaging apparatuses.

Next, the size of the optical filter 5 will be described.

In terms of the size of the optical filter 5, it is necessary for the diameter S thereof (refer to FIG. 1) to be larger than the diameters of the two object side lenses 12. For this reason, it is necessary to select an optical filter having a size reflecting the diameter G of the object side lens 12 because of being influenced by the diameter G of the object side lens 12. The filter diameters S of the optical filter which are generally available in the market are 49 mm, 52 mm, 55 mm, 58 mm, 62 mm, 67 mm, 72 mm, 77 mm, and 82 mm. In addition, as professional use large-diameter size filters, there are provided filters of 86 mm, 95 mm, 105 mm, and 112 mm.

When the presence of the commercial optical filters is considered, if a size of the female thread 39 in the ring portion 35 of the front member 22 is determined, it is possible to use low cost commercial products without manufacturing optical filters of special sizes through particular order. In addition, as described above, a value of the IAD (: Y) is preferably set in a range of 30<Y<60 (unit: mm). For this reason, in relation to the optical filter 5, the filter diameter S is set to the size of 67 mm to 112 mm.

For example, the diameter G of each of the object side lenses 12 and 12 of the two lens portions 3L and 3R may be set to 30 mm, the outer diameter of the lens barrel 11 may be set to 40 mm, the inter-axial distance (IAD: also referred to as “parallax”) of the two lens portions 3L and 3R may be set to 45 mm. In this case, the size of 77 mm to 112 mm may be employed as the filter diameter S of the optical filter 5. However, it is preferable to use the optical filter 5 in a range of 82 mm to 105 mm in consideration of workability in attachment and detachment of the filter, vignetting or flare in stereoscopic images obtained from a subject, and the like.

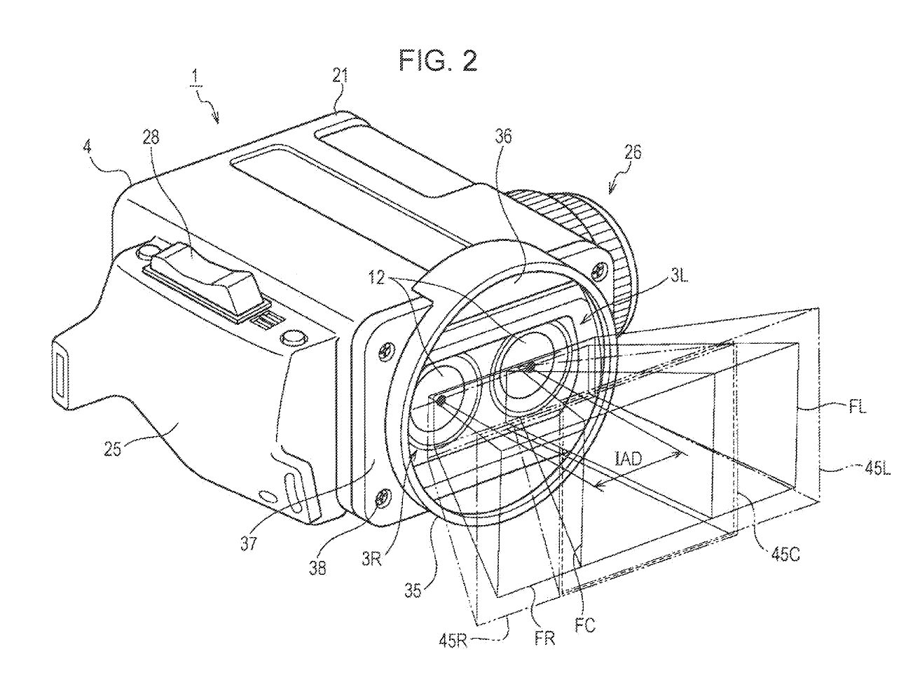

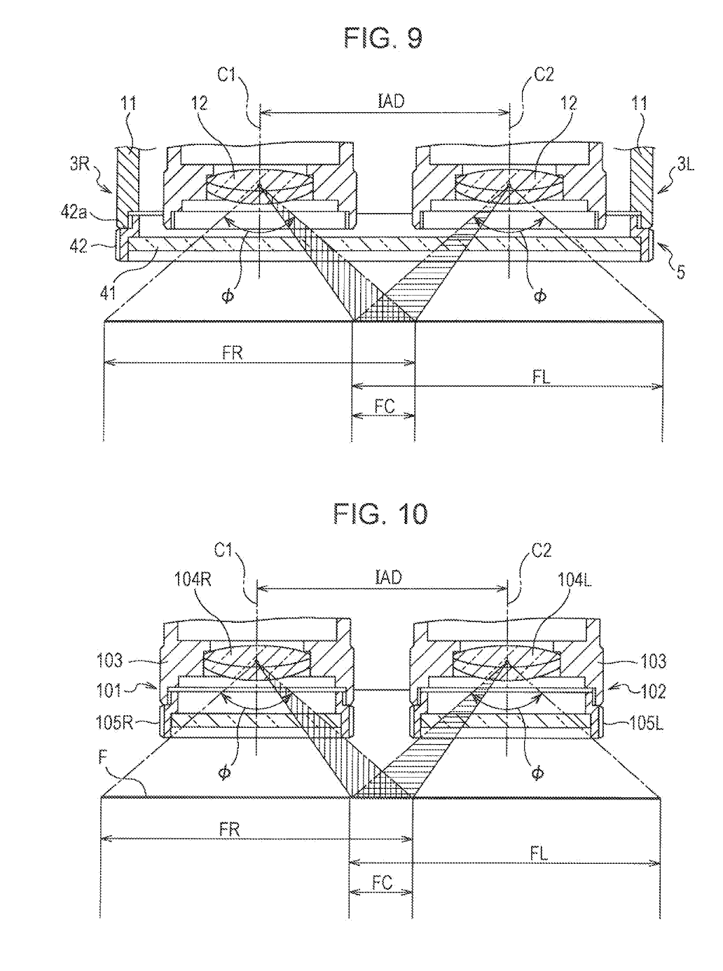

FIGS. 2 and 9 are ray diagrams of the left and right lens portions 3L and 3R. In FIG. 2, the reference numeral 45R denotes a frame portion of the right imaging device unit 9R (refer to FIG. 4), and the reference numeral 45L denotes a frame portion of the left imaging device unit 9L (refer to FIG. 4). The reference numeral 45C denotes an overlapping portion where the two frame portions 45R and 45L overlap each other. In addition, the reference numeral FR denotes the imaging surface by imaging of the right imaging device unit 9R (refer to FIG. 4), the reference numeral FL denotes the imaging surface by imaging of the left imaging device unit 9L (refer to FIG. 4), and the reference numeral FC denotes an overlapping surface where the two imaging surfaces FR and FL overlap each other. According to the embodiment of the present disclosure, since the object side lenses 12 and 12 of the two lens portions are covered by the single optical filter, it is possible to give the same filter effect to the two lens portions without generating different filter characteristics. In addition, in FIG. 9, the reference numeral C1 denotes an optical axis of the right lens portion 3R, and the reference numeral C2 denotes an optical axis of the left lens portion 3L. Further, the reference numeral φ denotes an incidence angle of light which is incident to each of the object side lenses 12 and 12 of the left and right lens portions 3L and 3R.

The lens hood 6 shown in FIG. 1 indicates a lens hood which is very suitable to be used for the two-lens device 1 according to an embodiment of the present disclosure. The lens hood 6 has a light blocking portion 6a which has a ring shape and is continuous so as to restrict light incidence, a rear surface portion 6b covering the rear surface of the light blocking portion 6a, and a fixing portion 6c which is provided at the center of the rear surface portion 6b and has a ring shape. A locking screw 47 is fitted to the fixing portion 6c. The fixing portion 6c of the lens hood 6 is fitted to the ring portion 35 of the lens case 4 or the frame portion 42 of the optical filter 5 so as to be attachable and detachable, and the lens hood 6 is fastened to the lens case 4 side by tightening of the locking screw 47.

As materials of the case body 21 and the front member 22 of the lens case 4, and the lens hood 6, for example, ABS (acrylonitrile butadiene styrene) resin or POM (polyacetal), and other plastic may be employed. However, materials of the case body 21 and the like are not limited thereto, and, for example, an aluminum alloy, stainless steel, steel, or other metals may be used.

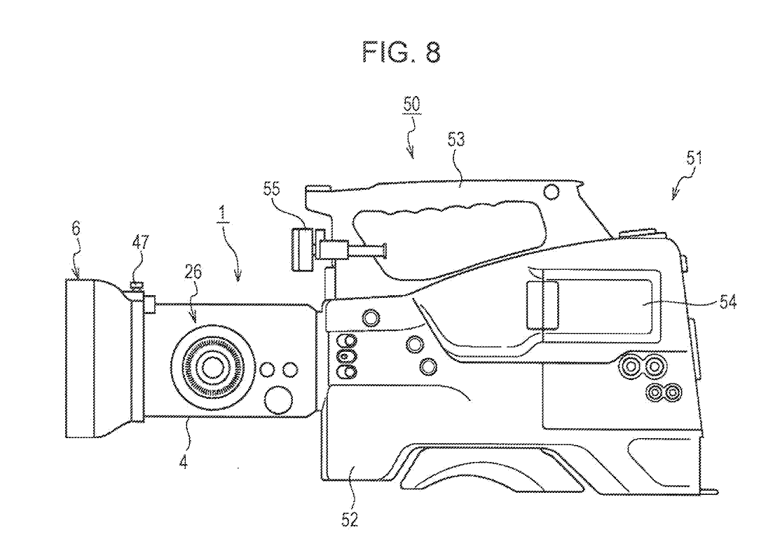

FIG. 8 shows a business use video camera 50 which is an example of the stereoscopic imaging apparatus with two-lens device having the two-lens device 1 according to the embodiment of the present disclosure. The video camera 50 includes an imaging apparatus body 51 and the two-lens device 1. The imaging apparatus body 51 includes an exterior case 52 made of plastic, an aluminum alloy, or the like, a control device accommodated inside the external case 52, and the like. The exterior case 52 is provided with a group of various interfaces for connection to an external device, a group of various operation buttons, a handle 53, a display portion 54, a battery adaptor, a memory card slot, and the like. The interfaces include, for example, input and output of digital video and digital audio, input and output of analog video and analog audio, an input for control, a monitor output, a headset output, and the like. A battery (not shown) is attachable to and detachable from the battery adaptor.

A part of the operation button group, the display portion 54, and the memory card slot are mainly disposed on the exterior case 52. The operation buttons include, for example, a power button, a recording button, a play button, a fast-forward button, a rewind button, a shutter button, and the like. The display portion 54 is used to display a user interface or the like for selecting or setting a video during imaging, a recorded video, or a variety of functions, and is provided on the lateral surface of the exterior case 52 so as to rotate in the two-axis direction. As the display portion 54, for example, a liquid crystal display or an organic EL display, or the like may be used. A memory card which is a semiconductor recording medium is attachable to and detachable from the memory card slot which records or reproduces digital video data on or from the memory card.

The handle 53 and the other part of the operation button group are provided on the upper surface of the exterior case 52. The handle 53 is a part for a user carrying the video camera 50, and a microphone 55 is fitted the front part of the handle 53. In addition, a control circuit such as a CPU (Central Processing Unit), a signal processing circuit, an encoder circuit, and the like are accommodated inside the exterior case 52.

The two-lens device 1 according to the embodiment of the present disclosure has a configuration where the single optical filter is disposed before the two lens portions 3L and 3R as shown in FIG. 9 or the like. For this reason, there is no concern that different filter characteristics are generated as in a device where optical filters are separately installed at two lens portions in the related art, and it is possible to give the same filter effect to the two lens portions at all times.

In addition, the present disclosure may have the following configurations.

(1) A two-lens device including two lens portions that are disposed so as to be laterally aligned; a lens case that supports the two lens portions in a state where a convergence point can be adjusted in order to image a subject as stereoscopic images by the two lens portions; and a filter installation portion at which a single circular optical filter covering the entire surface of the subject side of the two lens portions is installed so as to be attachable and detachable through thread connection on the subject side of the two lens portions of the lens case.

(2) The two-lens device set forth in (1), wherein the filter installation portion is formed from a cylindrical shaft portion having a thread section on the inner circumferential surface thereof.

(3) The two-lens device set forth in (2), wherein the thread section of the cylindrical shaft portion has a female thread which can be screwed into a male thread for thread connection provided in an optical filter which is commercially available.

(4) The two-lens device set forth in any one of (1) to (3), wherein an optical filter having a filter diameter in a range of 67 mm to 112 mm is installed at the filter installation portion.

(5) A stereoscopic imaging apparatus with two-lens device including a two-lens device that can image a subject as stereoscopic images; an imaging apparatus body at which the two-lens device is installed so as to be attachable and detachable; and two imaging device units that are fitted to the two-lens device or the imaging apparatus body and have imaging devices, wherein the two-lens device include two lens portions that are disposed so as to be laterally aligned; a lens case that supports the two lens portions in a state where a convergence point can be adjusted in order to image a subject as stereoscopic images by the two lens portions; and a filter installation portion at which a single circular optical filter covering the entire surface of the subject side of the two lens portions is installed so as to be attachable and detachable through thread connection on the subject side of the two lens portions of the lens case.

(6) The stereoscopic imaging apparatus with two-lens device set forth in (5), wherein an optical filter having a filter diameter in a range of 67 mm to 112 mm is installed at the filter installation portion.

(7) The stereoscopic imaging apparatus with two-lens device set forth in (5) or (6), wherein the diameter of an object side lens located at a position closest to the subject in each of the two lens portions is set to 45 mm or less.

(8) The stereoscopic imaging apparatus with two-lens device set forth in any one (5) to (7), wherein the length in a direction where the two lens portions are aligned in an imaging device IC mount substrate having the imaging device mounted thereon is set to 45 mm or less.

(9) The stereoscopic imaging apparatus with two-lens device set forth in any one of (5) to (7), wherein the size of the imaging device is set to ⅔ inch or less.

As described above, the present disclosure is not limited to the embodiment, and may include various modifications without departing from the scope of the present disclosure. Although the example where the present disclosure is applied to the business use video camera has been described in the embodiment, the present disclosure is naturally applied to a consumer use video camera, and other imaging apparatuses.

Although the example where the imaging device units are provided in the two-lens device in the above-described embodiment, the present disclosure is not limited thereto, and the imaging device units may be provided in the imaging apparatus body.

The present disclosure contains subject matter related to that disclosed in Japanese Priority Patent Application JP 2011-073321 filed in the Japan Patent Office on Mar. 29, 2011 and Japanese Priority Patent Application JP 2011-194623 filed in the Japan Patent Office on Sep. 7, 2011, the entire contents of which are hereby incorporated by reference.

It should be understood by those skilled in the art that various modifications, combinations, sub-combinations and alterations may occur depending on design requirements and other factors insofar as they are within, the scope of the appended claims or the equivalents thereof.

What is claimed is:

1. A two-lens device comprising:
two lens portions that are disposed so as to be laterally aligned;
a lens case that supports the two lens portions in a state where a convergence point can be adjusted in order to image a subject as stereoscopic images by the two lens portions; and
a filter installation portion at which a single circular optical filter covering the entire surface of the subject side of the two lens portions is installed so as to be attachable and detachable through thread connection on the subject side of the two lens portions of the lens case.

2. The two-lens device according to claim 1, wherein the filter installation portion is formed from a cylindrical shaft portion having a thread section on the inner circumferential surface thereof.

3. The two-lens device according to claim 2, wherein the thread section of the cylindrical shaft portion has a female thread which can be screwed into a male thread for thread connection provided in an optical filter which is commercially available.

4. The two-lens device according to claim 1, wherein an optical filter having a filter diameter in a range of 67 mm to 112 mm is installed at the filter installation portion.

5. A stereoscopic imaging apparatus with two-lens device comprising:
a two-lens device that can image a subject as stereoscopic images;
an imaging apparatus body at which the two-lens device is installed so as to be attachable and detachable; and
two imaging device units that are fitted to the two-lens device or the imaging apparatus body and have imaging devices,
wherein the two-lens device include
two lens portions that are disposed so as to be laterally aligned;
a lens case that supports the two lens portions in a state where a convergence point can be adjusted in order to image a subject as stereoscopic images by the two lens portions; and
a filter installation portion at which a single circular optical filter covering the entire surface of the subject side of the two lens portions is installed so as to be attachable and detachable through thread connection on the subject side of the two lens portions of the lens case.

6. The stereoscopic imaging apparatus with two-lens device according to claim 5, wherein an optical filter having a filter diameter in a range of 67 mm to 112 mm is installed at the filter installation portion.

7. The stereoscopic imaging apparatus with two-lens device according to claim 6, wherein the diameter of an object side lens located at a position closest to the subject in each of the two lens portions is set to 45 mm or less.

8. The stereoscopic imaging apparatus with two-lens device according to claim 6, wherein the length in a direction where the two lens portions are aligned in an imaging device IC mount substrate having the imaging device mounted thereon is set to 45 mm or less.

9. The stereoscopic imaging apparatus with two-lens device according to claim 6, wherein the size of the imaging device is set to ⅔ inch or less.
